(19) United States
(12) Patent Application Publication
(10) Pub. No.: US 2021/0291124 A1
(43) Pub. Date: Sep. 23, 2021

(54) SYSTEM AND METHOD OF REGULATING NUCLEATION

(71) Applicant: Kevin Montoya, Los Angeles, CA (US)

(72) Inventor: Kevin Montoya, Los Angeles, CA (US)

(21) Appl. No.: 16/826,752

(22) Filed: Mar. 23, 2020

(51) Int. Cl. B01F 3/04

(52) U.S. Cl. CPC B01F 3/04815; B01F 2003/049; B01F 3/04808

(57) ABSTRACT

A system and method to control the nucleation of gas from supersaturated liquids is disclosed. In some embodiments, the system and method is used to control the nucleation of carbonated bodies when combined with additive bodies that may cause an undesirable amount of nucleation. In some embodiments, the system and method is used to control the foam created when adding cocktail mixers to carbonated liquids such as beer and other types of carbonated beverages.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to the regulating of nucleation within liquids, including the regulating of CO₂ nucleation within carbonated bodies mixed with additive bodies.

### BACKGROUND

It is a well-known phenomenon for carbonated liquids, such as carbonated beverages, to foam excessively under certain conditions. For example, it is known that an agitated can or bottle of carbonated soda will foam explosively upon opening the container (e.g., with the release of pressure). It is also well known that carbonated beverages will foam when poured over ice, or when juice or other types of mixers are added to a carbonated drink.

In many cases, while a slight amount of foam is desirable to enhance the look, taste, mouth feel, and aromatics of the carbonated beverage, excessive foaming is not desirable as it causes “foam overs” (foam spillage over the top of the beverage glass) which are messy and wasteful.

Accordingly, there is a need for a system and method that controls the amount of foam produced when carbonated beverages are mixed with other substances (e.g., cocktail mixers).

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows example nucleation properties of a carbonated body according to exemplary embodiments hereof; and

FIG. 2 shows resulting foam volumes with respect to nucleation variance and pH levels.

### DETAILED DESCRIPTION OF EXEMPLARY EMBODIMENTS

In general, the system and method according to exemplary embodiments hereof includes a system and process to control the release of gas from supersaturated fluids. In some embodiments, the system and method includes a system and process to control the release of gaseous carbon dioxide (CO₂) from CO₂ supersaturated (carbonated) fluids. In some embodiments, the system and method includes a system and process to control the release of gaseous nitrogen (N) from nitrogen supersaturated fluids. It is understood by a person of ordinary skill in the art that the system and method according to exemplary embodiments herein may be used to control the release of any gas or of any combinations of gasses from supersaturated fluids that may contain the gas(ses). It is also understood that the scope of the system and method is not limited in any way by the specific gas and/or gasses that the system and method may be used to control.

For the purposes of this specification, the system and method will be described in relation to controlling the release of gaseous carbon dioxide (CO₂) from CO₂ supersaturated (carbonated) fluids. However, it is understood that the details provided herein may also apply to the control of other types of gasses that may be released from supersaturated fluids.

As is known in the art, dissolving CO₂ into a fluid (also referred to as a body) under pressure and temperature control creates a CO₂ supersaturated solution (e.g., a carbonated liquid). The supersaturated solution may generally hold the CO₂ within the solution until a nucleation event occurs. Nucleation is defined as the first step in the formation of either a new thermodynamic phase or a new structure of a compound via self-assembly or self-organization. In this case, nucleation is the release of the CO₂ from the solution into gaseous CO₂ (bubbles and/or foam). Nucleation events may include, without limitation, (i) the reduction of pressure (e.g., opening a bottle or can of a carbonated beverage and releasing the CO₂ as a gas), (ii) the adding of other elements or compounds into the supersaturated liquid (e.g., adding ice, fruit juice, seasonings, etc. into a carbonated beverage), (iii) pouring the supersaturated solution into a container with imperfections (e.g., pouring a beer into a mug), (iv) air entrapment and other types of events.

Nucleation sites are defined as sites where nucleation is triggered. For example, nucleation sites may include imperfections within a surface in physical contact with the carbonated body such as a microscopic crack in a glass or a rough surface that allows CO₂ to gather. Nucleation sites may also include organic and/or inorganic particulate(s) within the carbonated body and/or that may be introduced into the carbonated body (e.g., crystalline structures such as salts, ice and sugar). While nucleation sites may typically be unintentional, in some cases the nucleation sites may be purposely introduced (e.g., etchings on the glass surface) to deliberately trigger a desired amount of nucleation.

As the nucleated CO₂ gathers at a nucleation site, a bubble of gaseous CO₂ forms at the site. As more CO₂ nucleates, the bubble increases in size until it becomes buoyant. Once buoyant, the bubble may dislodge from the nucleation site and rise to the surface of the fluid. As the bubble passes through the carbonated body enroute to the surface, the CO₂ bubble itself may act as a nucleation site and gather additional CO₂ from the liquid, becoming larger and even more buoyant with increasing speed along the way. This process causes the nucleation site to nucleate even more CO₂. The size of the CO₂ bubble also may increase due to the reduction in atmospheric pressure as it moves upward through the liquid, however, this may have only a marginal effect. Once the bubble reaches the surface, it may either pop or remain as foam depending on the chemical composition of the surface liquid (e.g., the proteins, lipids, and enzymes that may exist on the surface).

In some embodiments, the system and method may be used to minimize the CO₂ foam that may result when mixing a carbonated body with an additive body. The additive body may typically be a liquid, a solid and any combination thereof. In one example, the additive body may include one or more cocktail “mixers” that may be added to beer (the carbonated body) to form a beer-based cocktail beverage (e.g., a michelada).

To expand on this example, as is known, a michelada cocktail is typically produced by starting with a beer base (e.g., a glass or mug of beer) and adding the michelada ingredients (the michelada mixer) directly into the beer. Michelada ingredients may include a shot of tomato juice combined with fruit juices (such as lime, lemon, orange, mango, and/or pineapple), a splash of clam or shrimp brine and authentic spices such as chili-lime salt, cumin, hot sauce, Maggi® seasoning and other ingredients. When the michelada ingredients are added to the beer (which is supersaturated with CO₂ and therefore highly carbonated), the ingredients of the michelada mixer may typically react explosively with the CO₂ solution within the beer, causing the carbonated solution to release gaseous CO₂ (via the process of nucleation) which rises to the surface of the beverage as bubbles. This may cause excessive amounts of unwanted foam at the top of the beverage (and many times foaming over the top causing spillage) that may take several minutes if not longer to dissipate.

It is known in the art that this scenario is not limited to the making of michelada beverages, and that many types of beverages and/or other types of supersaturated solutions suffer from the same problem of overflowing foam caused by the nucleation of CO₂ within the fluids. Accordingly, the system and method described herein may be used with any type of fluid that may benefit from the process.

In some exemplary embodiments hereof, the system and method may include at least some of the following steps (without limitation):
1. Adjusting, setting or otherwise controlling the pH level of the carbonated body (e.g., the CO₂ supersaturated solution such as beer);
2. Adjusting, setting or otherwise controlling the pH level of the additive body (e.g., the pH level of the mixer such as a michelada mixer);
3. Regulating the effects of nucleation sites within the additive body, e.g., by adjusting the additive body's viscosity (e.g., the viscosity of the mixer such as a michelada mixer);
4. Delivering the additive body (e.g., the michelada mixer) into the carbonated body (e.g., the beer) from above using a predefined and systematic pour pattern; and controlling the surface tension of the combined mixture (the controlled mixture being the combination of the carbonated body and the additive body together); and
5. Utilizing the alcohol content and setting the temperature of the carbonated body and/or of the additive body to destabilize the released gaseous CO₂ and to dissolve a portion of the released CO₂ back into the combined mixture.

The Process: Step 1

In one exemplary embodiment hereof, the carbonated body's CO₂ nucleation properties (the body's foaming properties) are determined as a function of the body's pH.

The term pH is a measure of the potential of hydrogen ions (concentration) within a solution and is calculated by the following equation:

pH=−log[H+]
where [H+] is the hydrogen ion concentration in units of moles per liter of solution.

The pH scale typically ranges from 0 to 14 and is a measure of the acidity and/or alkalinity of a solution. For example, aqueous solutions at 25° C. with a pH level less than 7.0 are considered acidic, while those with a pH level greater than 7.0 are considered basic or alkaline. A pH level of 7.0 at 25° C. is defined as “neutral” (e.g., pure water has equal concentrations of H₃O+ and OH−). Very strong acids may have a negative pH, while very strong bases may have a pH greater than 14.

In one exemplary embodiment hereof, the probability of CO₂ nucleation within the carbonated body vs. the body's pH level is measured at varying pH levels. For example, the pH level of the carbonated body may be adjusted to a first pH level and tested for CO₂ nucleation. The carbonated body's pH level may then be set to a second pH level and tested again for CO₂ nucleation. This process may be repeated with the pH level of the carbonated body set to pH levels within a set of desired pH levels and tested at each pH level for CO₂ nucleation. The nucleation may be triggered by applying any type of nucleation event, such as by adding a controlled additive (e.g., the additive of interest for the final product (e.g., the michelada mixer)).

In one exemplary embodiment hereof, the following steps are followed:
1. The pH level of the carbonated body is adjusted to a first pH level pH1;
2. A controlled volume of the carbonated body of (1) is provided in a reference container at a controlled temperature and pressure. For example, if the carbonated body is a beer, 12 oz of the beer may be provided in a 20 oz reference beer glass at a particular temperature. Care is preferably taken to minimize the nucleation (foaming) of the carbonated body during this process.
3. A controlled amount of an additive is added to the carbonated body within the reference container. For example, 4 oz of the michelada mixer (the additive) is added to the 12 oz of beer (the carbonated body) within the 20 oz reference beer glass. The physical adding of the additive to the carbonated body is preferably performed in a controlled and consistent manner. For example, the additive is poured into the center of the reference glass from a controlled height and at a controlled velocity.
4. The resulting foam volume (cm³) is measured.
5. The measured foam volume is optionally assigned an associated nucleation (or foaming) factor.
6. Steps 1-5 may be repeated for different pH levels pHn (as adjusted in step 1) where n equals the number of pH levels in the set of desired pH levels.

It is understood that the steps outlined above are meant for demonstration and that other steps may also be performed. In addition, it is understood that not all of the steps may be necessarily taken.

In some embodiments hereof, the pH level of the carbonated body is sequentially adjusted to pH levels such as 1, 2, 3, 4, 5, 6, 7, 8, 9, 10, 11, 12, 13 and 14. In some embodiments, the pH levels may be set to specific levels and the resulting foam volume data may be extrapolated therebetween.

This data may then be used to determine and/or predict the optimal pH level of the carbonated body for the production of the carbonated mixture to produce a desired amount of foam.

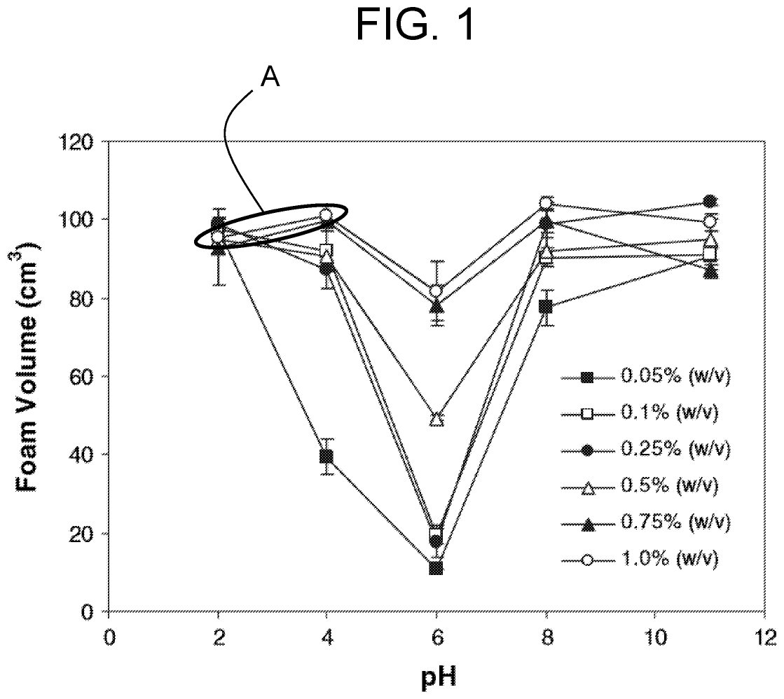

As an example, FIG. 1 shows the effects of varying pH levels on nucleation at different concentrations of barley protein isolate produced from hulled barley flower. The uptick in nucleation caused by an increase in weight to volume ratio (w/v) (i.e., increase in nucleation sites) at pH levels between 2.0 and 4.22 pH are encircled in bold at A, and is further evaluated in Table 1 below.

Table 1 illustrates the differences in nucleation at varying pH levels when nucleation sites are added to a carbonated body. Controlled ratios of beer and sodium were used with the daily value of sodium being the measure of nucleation sites. Noted in bold are excessive foam levels. Excessive foam is defined as greater than 25% of the 16 oz body, or 118 cm³, which causes a standard 20 oz glass to overflow when the ratios of sodium and beer are combined. The uptick in nucleation encircled in bold in FIG. 1 is demonstrated in this table. As pH tends towards 4.22 and the carbonated body becomes more basic, excessive foam reactions may occur even with a lesser number of nucleation sites; whereas, when the solution becomes more acidic, excessive foam reactions may require more nucleation sites to occur.

In one exemplary embodiment hereof, this data and/or data similar to this may be used to optimize and/or align the pH levels of the carbonated body and the additive body for the desired level of nucleation and resulting foam.

TABLE 1

| % DV | pH | | pH | | pH | | pH | |
|---|---|---|---|---|---|---|---|---|
| Sodium | 4.22 | | 4.06 | | 3.95 | | 3.56 | |
| 34% | | | | | | | 161 | cm³ |
| 32% | | | | | | | 114 | cm³ |
| 30% | | | | | 132 | cm³ | 90 | cm³ |
| 28% | | | | | 85 | cm³ | | |
| 26% | | | 137 | cm³ | 52 | cm³ | | |
| 24% | 132 | cm³ | 114 | cm³ | | | | |
| 22% | 104 | cm³ | 66 | cm³ | | | | |
| 20% | 52 | cm³ | | | | | | |

Table 2 shown below demonstrates a significant reduction in nucleation at varying pH levels when an additive body is adjusted (A-pH) using this process.

TABLE 2

| % DV | pH | pH | pH | pH |
|---|---|---|---|---|
| Sodium | 4.22 | 4.06 | 3.95 | 3.56 |
| 28% | 7 cm³ | 6 cm³ | 5 cm³ | 5 cm³ |
| 26% | 6 cm³ | 5 cm³ | 5 cm³ | 4 cm³ |
| 24% | 5 cm³ | 5 cm³ | 4 cm³ | 4 cm³ |

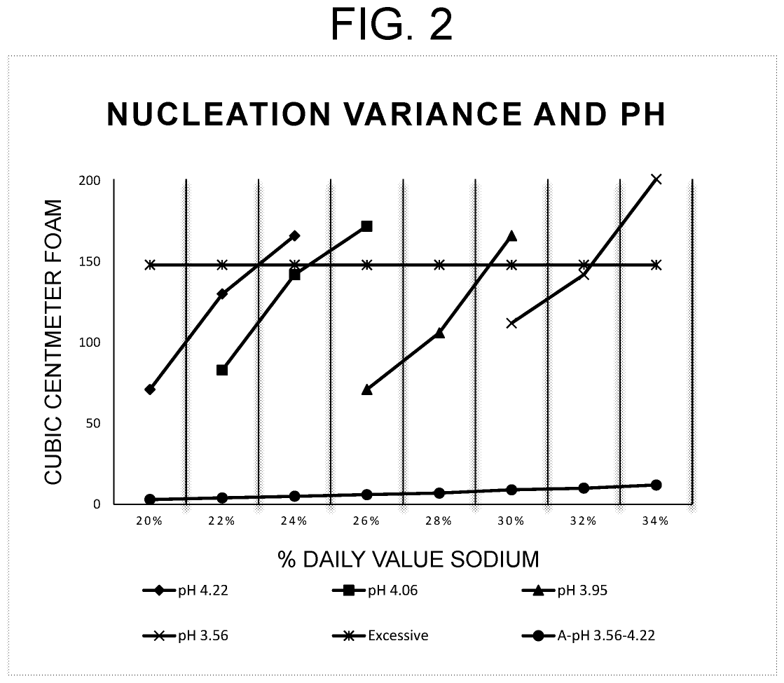

FIG. 2 illustrates the contrasts in data between Table 1 and Table 2.

In some embodiments, the pH level of the carbonated body may be adjusted through natural processes, by adding additional ingredients, and/or through the processes of acidification and/or basification. Acidification is the process of lowering a body's pH to a level below pH 7.00. This can be accomplished by adding a substance such as citric acid (e.g., with a pH of about 3.2), calcium chloride and/or any other suitable substance to the body. Basification, on the other hand, is the process of increasing the body's pH to a level above pH 7.00 by adding substances such as sodium bicarbonate to the body.

The Process: Step 2

In one exemplary embodiment hereof, the chemical properties of the additive body are controlled and aligned with the chemical properties of the carbonated body (e.g., the chemical properties of the carbonated body as determined in Step 1 above). This may include controlling the additive body's pH level(s), addressing chemical reactions that may occur with the adding of the additive body to the carbonated body, and affecting any nucleation sites that may exist and/or that may be formed during this process.

When an additive body is mixed with a carbonated body, the chemicals within the additive body's chemical profile may react with the chemicals within the carbonated body's chemical profile to cause one or more chemical reactions. As is known in the art, a chemical reaction is a process in which one or more substances, the reactants, are converted to one or more different substances, the products. Substances are either chemical elements or compounds. A chemical reaction rearranges the constituent atoms of the reactants to create different substances as products.

Also, chemical reactions may be exothermic or endothermic.

An exothermic reaction releases heat, causing the temperature of the immediate surroundings to rise, while an endothermic reaction absorbs heat and cools the surroundings.

In one exemplary embodiment hereof, chemical reactions that occur when the additive body is mixed with the carbonated body create nucleation sites that are then minimized by the method and system 10.

In one example, the mixing of the additive body to the carbonated body causes a chemical reaction that results in the production of salt. Salt is a crystalline structure that acts as a nucleation site causing the release of the CO2 from the carbonated body.

As is known in the art, salts are the byproduct of various types of acid base reactions. Salts are formed by the joining of a cation from a base and the anion from an acid. For example, hydrochloric acid reacts with sodium hydroxide to form sodium chloride (a salt) and water. Sodium chloride is made up of Na+ cations from the base (NaOH) and Cl− anions from the acid (HCl). These come together to make NaCl. Moreover, as an acid and base react, a crystalline structure (salt) is formed, and in the case of a michelada mixer and beer with misaligned pH levels, the presence of more crystalline structures exacerbates nucleation.

As salt is produced within the carbonated body due to the mixing of the additive body, CO₂ gathers at the nucleation sites (the crystalline salt structures) and reacts rapidly, causing an abundance of CO₂ within the carbonated body to nucleate and form foam.

In addition, the reaction is exothermic, causing the temperature of the carbonated body to rise. As is known in the art, CO₂ is more easily dissolved into liquids at lower temperatures. Accordingly, the release of heat by the exothermic reaction caused by the mixing of the additive body excites the molecules within the carbonated body and destabilizes the CO₂ within the carbonated body causing a more volatile foam.

In one exemplary embodiment hereof, the nucleation sites resulting from the production of salt within the carbonated body as described above are reduced using the process of acidification and/or basification. For the purposes of this specification, these nucleation sites will be referred to as produced nucleation sites NS_{P}. In one embodiment, the reduction of the produced nucleation sites NS_{P} is achieved by adding citric acid, sodium bicarbonate, calcium chloride and/or similar to the additive body prior to the mixing of the additive body to the carbonated body. In one exemplary implementation, citric acid is added to the additive body. In one exemplary embodiment, citric acid is added to the additive body in the amount of about 47.130 lbs/1,000 gal, or about 0.5500% of total formulation.

In other embodiments, one or more of the following (without limitation) may be added to the additive body to adjust its pH level: acetic acid, adipic acid, ammonium aluminum sulphate, ammonium bicarbonate, ammonium citrate, ammonium hydroxide, ammonium phosphate, calcium acid pyrophosphate, calcium carbonate, calcium chloride, calcium citrate, calcium fumarate, calcium gluconate, calcium hydroxide, calcium lactate, calcium oxide, calcium phosphate, calcium sulphate, citric acid, cream of tartar, fumaric acid, gluconic acid, glucono-delta-lactone, hydrochloric acid, lactic acid, magnesium carbonate, magnesium fumarate, magnesium hydroxide, magnesium phosphate, magnesium sulphate, malic acid, manganese sulphate, metatartaric acid, phosphoric acid, potassium acid tartrate, potassium aluminum sulphate, potassium bicarbonate, potassium carbonate, potassium chloride, potassium citrate, potassium fumarate, potassium hydroxide, potassium lactate, potassium phosphate, potassium pyrophosphate, potassium sulphate, potassium tartrate, potassium tripolyphosphate, sodium acetate, sodium acid pyrophosphate, sodium acid pyrophosphate, sodium aluminum phosphate, sodium aluminum sulphate, sodium bicarbonate, sodium bisulfate, sodium carbonate, sodium citrate, sodium fumarate, sodium gluconate, sodium hexametaphosphate, sodium hydroxide, sodium lactate, sodium phosphate, sodium potassium hexametaphosphate, sodium potassium tartrate, sodium potassium tripolyphosphate, sulphuric acid, sulphurous acid, and/or tartaric acid.

In one exemplary embodiment hereof, the produced nucleation sites NS_{P} resulting from the production of salt within the carbonated body as described above are reduced by adding a buffer to the additive body prior to the mixing of the additive body to the carbonated body. In one embodiment, the buffer may include a mixture of a weak acid and its conjugate base or a weak base and its conjugate acid. The buffer may react with the acids and/or bases within the mixture of the additive body and the carbonated body to control the overall body's pH level.

Once the pH level of the additive body is aligned with the pH level of the carbonated body, the creation of nucleation sites (salts) and the resulting exothermic reactions will be significantly reduced. In one exemplary embodiment hereof, the pH level of the carbonated body is formed and/or adjusted to be about 3.0-4.2 and the pH level of the additive body is formed and/or adjusted to be about 3.11+/−0.20. In some embodiments, the carbonated body is formed as a beer (e.g., a lager or pilsner beer) with a pH level of about 2.5-5.0. In other embodiments, the carbonated body is formed as a beer with a pH level of about 3.0-4.2. In some embodiments, the additive body is formed as a michelada mixer with a pH level of about 2.5-5.0 to be generally aligned with the carbonated body (e.g., the beer). In some embodiments, the additive body is formed as a michelada mixer with a pH level of about 3.0-4.2 to be generally aligned with the carbonated body (e.g., the beer).

The Process: Step 3:

In one exemplary embodiment hereof, pre-existing nucleation sites NS_{E} within the additive body are controlled and/or adjusted as necessary to regulate the effects of the pre-existing nucleation sites NS_{E} as they are introduced into the carbonated body. In one embodiment, the additive body may include salts and/or proteins that may act as nucleation sites (NS_{E}) once introduced into the carbonated body, and these pre-existing nucleation sites NS_{E} may be affected by the system 10 and method prior to the adding of the additive body to the carbonated body. In this way, nucleation caused by these pre-existing nucleation sites NS_{E} may be regulated by the system 10 and method.

In one exemplary embodiment hereof, the system 10 and method slows the accumulation (the nucleation) of the CO₂ at the pre-existing nucleation sites NS_{E} by increasing the viscosity of the additive body. In one embodiment, the viscosity of the additive body is increased by the addition of stabilizers, thickening agents, and gel agents including vegetable gums, starches, sugars, pectins, proteins, glycerides, and synthetics. Vegetable gums may include guar gum, xanthan gum, locust bean gum, and other types of vegetable gums. Starches may include maltodextrin, arrowroot, arrowroot, cornstarch, potato starch, sago, tapioca, and other starches. Sugars may include agar, carrageenan, and other sugars. Pectins may include fruit-based thickeners and other pectins. Proteins may include collagen, gelatin, egg whites, whey, and other proteins. Mono- and diglycerides such as those present in seed oils and other sources may be used. Synthetics may include carboxymethyl cellulose, methyl cellulose, and other synthetics. Other viscosity increasing agents may also be used. In one exemplary embodiment hereof, a thickening agent such as xanthan gum is added to the additive body in the amount of 0.01%-0.1% of the total volume of the additive body.

In one exemplary embodiment hereof, the system 10 and method slows the nucleation process by adding an anti-caking agent (e.g., silicon dioxide) to the additive body (e.g., to a dry ingredient additive body) to encapsulate pre-existing nucleation sites NS_{E} within the additive body. When the additive body (and the encapsulated pre-existing nucleation sites NS_{E} within the additive body) are subsequently added to the carbonated body, the encapsulation surrounding the pre-existing nucleation sites NS_{E} will act as a temporary barrier between the carbonated body and the pre-existing nucleation sites NS_{E}. Accordingly, the nucleation process may not occur until the encapsulation dissolves within the mixture, thereby delaying the nucleation by the amount of time it takes for the encapsulation to dissolve.

In one exemplary embodiment hereof, the system 10 and method increases the viscosity of the additive body thereby reducing the speed at which the supersaturated CO₂ within the carbonated body reaches the pre-existing nucleation sites NS_{E} upon the introduction of the pre-existing nucleation sites NS_{E} into the carbonated body. The diffusion of the CO₂ through the additive body to the pre-existing nucleation sites NS_{E} is slowed and the time it takes for nucleation to occur at the sites is thereby increased. That is, the pre-existing nucleation sites NS_{E} are generally encapsulated by the additive body itself (due to its increased viscosity) thus reducing the speed at which the CO₂ may collect at the sites and thereby slowing the nucleation process.

In addition, because the speed of nucleation at the pre-existing nucleation sites NS_{E} is reduced, the amount of time for each nucleating CO₂ bubble to gain sufficient size and buoyancy to dislodge and rise to the surface (and become foam) is also increased. Also, the speed at which the dislodged CO₂ bubble may rise is slowed due to the higher viscosity of the overall mixture (due to the controlled viscosity of the additive body) so that the bubble travels at a slower velocity and gathers less additional nucleated CO₂ along the way.

The system 10 and method is preferably used to adjust the viscosity of the additive body to reduce but not entirely eliminate the resulting foam produced by the mixing of the bodies. For instance, using the beer-based cocktail beverage described above (e.g., a michelada) as an example, a small amount of foam at the top of the resulting cocktail mixture is preferable for to optimize the look, taste, aromatics, and mouth feel of the beverage.

The Process: Step 4

In one exemplary embodiment hereof, the surface tension of the combined carbonated body and additive body mixture is controlled and adjusted to generally contain the additive body below the surface of the combined mixture during the mixing process of the two bodies (the mixing of the additive body to the carbonated body). In one embodiment, the viscosity of the additive body is controlled and adjusted to be such that upon mixing the additive body with the carbonated body, the additive body facilitates the increase of surface tension of the resulting combined mixture.

In one embodiment, the additive body is added to the carbonated body by pouring the additive body over-top the carbonated body. The controlled viscosity of the additive body adds to the viscosity of the combined mixture thereby increasing the surface tension of the combined mixture. As the additive body is poured into the carbonated body from above (over-top), air is entrained increasing the momentum of the additive body as it enters into and passes downward through the carbonated body. The bulk of the additive body travels toward the bottom of the glass and upon reaching the bottom banks upward, while the peripheral portions of the additive body spread thin and mix with the carbonated body. This mixing increases the viscosity of the combined mixture thereby increasing the combined mixture's surface tension in parallel. The surface tension of the mixture is affected by the viscosity of the additive body, the surface tension of the carbonated body's surfactant molecules (e.g., those naturally present in beer) and other elements and/or conditions.

As the bulk of the additive body turns upward after reaching the bottom of the glass, the increased viscosity and the increased surface tension of the combined mixture slows the additive body's upward movement, while the force of gravity pulls the additive body back downward in a reversed direction. This creates a natural convection within the combined mixture.

At this point, the combined mixture's profile may include areas of varying viscosities (due to the varying mixing rates in different areas of the glass of the additive body and the carbonated body) such that chemical reactions between the bodies (e.g., such as those described in other sections) may occur at different rates in different areas of the mixture. Nucleation in turn, may also occur at different rates in different areas of the mixture due to different rates that nucleation sites may form in the mixture and the differing rates that the CO₂ may form at each site. Accordingly, some gaseous CO₂ bubbles may form at faster rates than others, allowing the faster-forming bubbles to dislodge and rise to the surface as foam while restricting others within the mixture. The entrained air may also act as nucleation sites as it disperses through the mixture.

In one exemplary embodiment hereof, the over-top pour is performed in a circular motion over the top of the carbonated body. In this way, the additive body enters and passes downward into the carbonated body in different locations within the carbonated body, causing multi-directional currents within the mixture that may interact (e.g., collide) and agitate one another. Chemical reactions take place and nucleation sites are formed while being generally contained beneath the top surface (due to the increases surface tension of the combined mixture). The surface tension of the top surface also limits the loss of the carbonation. These events in combination facilitate a desired amount of nucleation to occur and a desired amount of foam to gather at the top of the beverage. In this way, the combined mixture results in a self-mixing and self-nucleation-regulating system.

In one embodiment, the viscosity of the additive body is adjusted (e.g., as described in other sections) to account for this combined behavior of the additive body and the carbonated body as the two bodies are mixed to produce the desired amount of nucleation and resulting foam.

The Process: Step 5

In one exemplary embodiment hereof, the alcohol content of the combined mixture (e.g., from the beer) is used to destabilize the foam that has formed due to nucleation of CO₂ within the combined mixture. This utilizes the solvency characteristic of the alcohol. In one embodiment, CO₂ bubbles trapped beneath the surface of the combined mixture (due to the increased surface tension) are destabilized by the alcohol within the combined mixture, causing the trapped foam to diffuse and dissipate, thus reducing the overall foam content.

In one embodiment, temperature is used to facilitate the reabsorption of the CO₂ into the combined mixture. By lowering the temperature of the combined mixture, the solubility of the CO₂ released from the mixture is increased so that a portion of the released CO₂ may be reabsorbed into the combined reduced-temperature mixture. This increases the carbonation content of the combined mixture while reducing the gaseous CO₂ bubbles.

It is understood by a person of ordinary skill in the art, upon reading this specification, that the system and method described may be used for any type of carbonated body, any type of additive body, any type of combined mixture (of one or more carbonated bodies with one or more additive bodies) and any combination thereof. For example, the system and method may be used to control the nucleation of different types of soft drinks when mixed with other ingredients and flavors (e.g., cherry cola), of sparkling water when mixed with juices to form spritzers for sparkling margaritas, of champagne when mixed with juice to make mimosas, of energy drinks formed from sparkling water and supplement powder, and any other types of combinations of carbonated bodies with additive bodies. It is understood that this list of examples is meant for demonstration and that the scope of the system and method is not limited in any way by the types of carbonated bodies and/or the types of additive bodies that may be used with the system and method.

Additional details of the system and method will be described by way of examples.

### Example 1

In a first example, a Michelada beverage mixer was created using the following ingredients and amounts (% of whole) according to the system and method.

Filtered water—59%

Tomato Paste—8.5%

Lime Juice—25%

White Vinegar—3.75%

Sea Salt—1.3%

Dustless black pepper—0.01%

Chili-lime seasoning—0.1725%

Maltodextrin—0.1725%

Monopotassium glutamate—0.3%

Yeast Extract—0.05%

Natural Flavorings—0.75%

Capsicum—0.004%

Cayenne pepper—0.1%

Citric Acid—0.55%

Smoked Sweet Paprika—0.05%

Each of these ingredients were chosen to do one, or more, of the following: nucleation site reduction, acidify, basify, increase viscosity, and/or dissolve, unless otherwise noted. The Michelada beverage mixer was then added to a beer to form a Michelada beverage. In some embodiments, one part of Michelada beverage mixer is added to three parts beer (a 3:1 ratio of beer to Michelada mixer) to form a Michelada beverage. In some embodiments, about 118 milliliters of Michelada mixer is added to about 354 milliliters (about 12 ounces, or one 12-ounce beer) to form a Michelada beverage.

In one embodiment, the filtered water (70.009 ml/118 ml) prevents the introduction of additional nucleation sites by ensuring minerals and particulates are removed before formulation. In addition to making up the majority of the mixture, filtered water dissolves ingredients and is more basic than any other ingredient. The other ingredients work to acidify this disparity in pH level.

In one embodiment, the tomato paste (10.03 g/118 ml) is used to measure and control the sodium content of the mixture and the resulting nucleation as well as increase the viscosity of the mixture. The tomato paste also works to acidify the mixture and add flavor.

In one embodiment, the lime Juice (29.5 g/118 ml) serves as the primary flavoring for the mixture while providing acidification to the solution.

In one embodiment, the white vinegar (4.425 g/118 ml)—a 12% commercial-grade high-acidity concentration—was chosen to acidify the solution. This ingredient also amplifies the beverage's tang without the need for more lime juice and its accompanying nucleation causing particulates.

In one embodiment, the fine sea salt (1.534 g/118 ml) & dustless black pepper (0.0118 g/118 ml) are used because of the small size of the grind and the resulting reduction of nucleation. Keeping the coarse surface area of the ingredients to a minimum reduces the size of nucleation sites relative to a coarse grind which would act as a larger nucleation site.

In one embodiment, the maltodextrin (0.1725 g/118 ml) is used as a thickening agent and increases the viscosity of the solution, which leads to a delayed CO2 aggregation and the subsequent nucleation.

In one embodiment, the monopotassium glutamate (MPG) (0.354 g/118 ml) is a non-sodium alternative to monosodium glutamate (MSG). MPG is used to reduce sodium and associated nucleation while also enhancing flavor.

In one embodiment, the yeast extract (0.0590 g/118 ml) is an extract used for flavoring, in lieu of MSG, to reduce sodium and associated nucleation.

In one embodiment, the natural flavorings (0.885 g/118 ml) & Capsicum (0.0047 g/118 ml) aqueous and high dissolving formulas were chosen to reduce the impact of nucleation sites in the solution.

In one embodiment, the citric acid (0.649 g/118 ml) is used to lower the acidity of the solution while adding a sour taste.

In one embodiment, the chile lime seasoning (0.1725 g/118 ml), smoked sweet paprika (0.0590 g/118 ml) & cayenne pepper (0.118 g/118 ml) add flavor.

In one embodiment, the beer (12 oz per 4 oz (118 ml)) contains alcohol which has foam negating effects.

### Example 2

In a second example, a Michelada beverage mixer was created using the following ingredients and amount ranges (% of whole) according to the system and method. About 118 milliliters of the Michelada beverage mixer was then added to a 12 oz beer to form a Michelada beverage.

Water—0-100%

Tomato paste >5%

Lime juice >15%

Vinegar >2%

Citric acid >0.25%

In some embodiments, the use of the following ingredients were chosen to reduce the impact of nucleation sites. These ingredients lightly react due to texture but may not produce significant nucleation between the levels mentioned:

Dustless black pepper 0-1 g

Monopotassium glutamate 0-1 g

Yeast extract—0-0.65 g

Sea Salt 0-0.9 g

Chili-lime seasoning 0-5 g

In some embodiments, the following ingredients may be added for flavoring and may not produce significant nucleation at and below 100% concentration:

Natural Flavorings

Capsicum

Cayenne pepper

Paprika

In some embodiments, the following ingredients may increase the viscosity of the solution by which CO₂ aggregation may be slowed and the volatility of nucleation may be reduced. These ingredients can be adjusted in respect to one another:

Maltodextrin >0.1%

Tomato Paste >1%

In some embodiments, the following amount of beer may be used. In some embodiments, the alcohol content in the beer may be used for its foam negating effects:

Beer: 1-4:1 ratio of 5% alcohol by volume (ABV)

Examples end here.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

I claim:

1. A method of forming an additive body for mixing with a supersaturated body to form a beverage with regulated nucleation, the method comprising the steps of:
(A) providing a supersaturated body;
(B) determining the pH level of the supersaturated body;
(C) providing an additive body;
(D) adjusting the pH level of the additive body; and
(E) adjusting the viscosity of the additive body.

2. The method of claim 1 wherein the supersaturated body includes a carbonated body.

3. The method of claim 1 wherein the pH level of the additive body is adjusted in (D) based on the pH level of the supersaturated body determined in (B).

4. The method of claim 1 wherein the pH level of the additive body is adjusted in (D) to substantially match the pH level of the supersaturated body determined in (B).

5. The method of claim 4 wherein the pH level of the supersaturated body determined in (B) is about 2.5-5.0 and the pH level of the additive body is adjusted in (D) to be about 2.5-5.0.

6. The method of claim 4 wherein the pH level of the supersaturated body determined in (B) is about 3.0-4.2 and the pH level of the additive body is adjusted in (D) to be about 3.0-4.2.

7. The method of claim 4 wherein the pH level of the additive body is adjusted in (D) to be about 3.11+/−0.20.

8. The method of claim 1 wherein the pH level of the additive body is adjusted in (D) by adding an ingredient to the additive body selected from the group: acetic acid, adipic acid, ammonium aluminum sulphate, ammonium bicarbonate, ammonium citrate, ammonium hydroxide, ammonium phosphate, calcium acid pyrophosphate, calcium carbonate, calcium chloride, calcium citrate, calcium fumarate, calcium gluconate, calcium hydroxide, calcium lactate, calcium oxide, calcium phosphate, calcium sulphate, citric acid, cream of tartar, fumaric acid, gluconic acid, glucono-delta-lactone, hydrochloric acid, lactic acid, magnesium carbonate, magnesium fumarate, magnesium hydroxide, magnesium phosphate, magnesium sulphate, malic acid, manganese sulphate, metatartaric acid, phosphoric acid, potassium acid tartrate, potassium aluminum sulphate, potassium bicarbonate, potassium carbonate, potassium chloride, potassium citrate, potassium fumarate, potassium hydroxide, potassium lactate, potassium phosphate, potassium pyrophosphate, potassium sulphate, potassium tartrate, potassium tripolyphosphate, sodium acetate, sodium acid pyrophosphate, sodium acid pyrophosphate, sodium aluminum phosphate, sodium aluminum sulphate, sodium bicarbonate, sodium bisulfate, sodium carbonate, sodium citrate, sodium fumarate, sodium gluconate, sodium hexametaphosphate, sodium hydroxide, sodium lactate, sodium phosphate, sodium potassium hexametaphosphate, sodium potassium tartrate, sodium potassium tripolyphosphate, sulphuric acid, Sulphurous acid, and tartaric acid.

9. The method of claim 1 wherein the pH level of the additive body is adjusted in (D) by adding citric acid to the additive body in an amount of about >0.25% of the total volume of the additive body.

10. The method of claim 1 wherein the pH level of the additive body is adjusted in (D) by adding citric acid to the additive body in an amount of about 0.6 grams per 118 milliliters of additive body.

11. The method of claim 1 wherein the viscosity of the additive body is adjusted in (E) by adding an ingredient to the additive body selected from the group: vegetable gum, starch, sugar, pectin, protein, glyceride, and synthetic.

12. The method of claim 1 wherein the viscosity of the additive body is adjusted in (E) by adding xanthan gum to the additive body in the amount of about 0.01%-0.1% of the total volume of the additive body.

13. The method of claim 1 wherein the viscosity of the additive body is adjusted in (E) by adding maltodextrin to the additive body in an amount of about 0.2 grams per 118 milliliters of additive body.

14. The method of claim 1 wherein the viscosity of the additive body is adjusted in (E) by adding tomato paste to the additive body in an amount of about 5%-9% of the total volume of the additive body.

15. The method of claim 1 wherein the viscosity of the additive body is adjusted in (E) by adding tomato paste to the additive body in an amount of about 10 grams per 118 milliliters of additive body.

16. The method of claim 1 wherein the supersaturated body includes beer and the additive body includes michelada mixer.

17. A beverage mixer for controlling nucleation when mixing with a supersaturated body to form a beverage, the beverage mixer comprising:
water in the amount of about 59% of the total beverage mixer fluid volume;
tomato paste in the amount of about 8.5% of the total beverage mixer fluid volume;
lime juice in the amount of about 25% of the total beverage mixer fluid volume;
vinegar in the amount of about 4% of the total beverage mixer fluid volume;
maltodextrin in the amount of about 0.2% of the total beverage mixer fluid volume;
citric acid in the amount of about 0.6% of the total beverage mixer fluid volume; and
other ingredients in the amount of about 2.7%.

18. The beverage mixer of claim 17 wherein the pH level of the beverage mixer is about 2.5-5.0.

19. The beverage mixer of claim 17 wherein the pH level of the beverage mixer is about 3.0-4.2.

20. The beverage mixer of claim 17 wherein the pH level of the beverage mixer is about 3.11+/−0.20.
